(19) United States
(12) Patent Application Publication
(10) Pub. No.: US 2024/0308299 A1
(43) Pub. Date: Sep. 19, 2024

(54) VEHICLE VENT DUCT

(71) Applicant: TOYOTA JIDOSHA KABUSHIKI KAISHA, Toyota-shi (JP)

(72) Inventor: Masayuki OKANO, Toyota-shi (JP)

(73) Assignee: TOYOTA JIDOSHA KABUSHIKI KAISHA, Toyota-shi (JP)

(21) Appl. No.: 18/395,932

(22) Filed: Dec. 26, 2023

(30) Foreign Application Priority Data
Mar. 17, 2023 (JP) 2023-042927

(51) Int. Cl. B60H 1/34; B60H 1/00

(52) U.S. Cl. CPC B60H 1/3421; B60H 1/00564

(57) ABSTRACT

The vehicle vent duct includes a duct body that is attached to the vehicle body and includes an opening that communicates between the inside of the vehicle cabin and the outside of the vehicle cabin, and a locking claw provided at the upper edge of the opening. The valve body is made of a flexible material and is pivotally locked to a locking pawl in the duct body to cover the opening. The locking claw portion is provided with a swing limiting portion that limits the swing of the upper portion of the valve body.

### CROSS-REFERENCE TO RELATED APPLICATION

This application claims priority to Japanese Patent Application No. 2023-042927 filed on Mar. 17, 2023, incorporated herein by reference in its entirety.

### BACKGROUND

### 1. Technical Field

The present disclosure relates to a vehicle vent duct.

### 2. Description of Related Art

Japanese Unexamined Patent Application Publication No. 2015-171843 (JP 2015-171843 A) discloses a vent duct including a duct body and a valve body. In the vent duct described in JP 2015-171843 A, an insertion hole of the valve body is inserted into a mounting pin provided in the duct body in a swingable manner. The vent duct described in JP 2015-171843 A has a structure that allows the valve body to swing significantly toward the outside of a vehicle cabin by devising the shape of the insertion hole of the valve body.

### SUMMARY

However, in the vent duct disclosed in JP 2015-171843 A, noise may enter the vehicle cabin due to the valve body flapping caused by the influence of airflow, vibrations of a vehicle, and the like while the vehicle is traveling. On the other hand, when the mass of the valve body is increased, the flapping of the valve body can be suppressed. However, the ventilation performance, which is the original function of the vent duct, may deteriorate.

The present disclosure has been made in consideration of the above fact. An object of the present disclosure is to obtain a vehicle vent duct that can suppress entry of noise into the vehicle cabin while maintaining the ventilation performance.

A vehicle vent duct according to claim 1 of the present disclosure includes: a duct body that is attached to a vehicle body and configured to include an opening that communicates an inside of a vehicle cabin with an outside of the vehicle cabin, and a locking claw portion provided at an upper edge of the opening; and a valve body that is locked to the locking claw portion of the duct body in a swingable state and covers the opening, the valve body being made of a flexible material, in which the locking claw portion is provided with a swing limiting portion that limits swing of an upper portion of the valve body.

The vehicle vent duct according to claim 1 of the present disclosure includes the duct body that is attached to the vehicle body. The duct body includes the opening that communicates the inside of the vehicle cabin with the outside of the vehicle cabin. Further, the locking claw portion is provided at the upper edge of the opening in the duct body. The valve body is locked to this locking claw portion in a swingable state. The valve body is made of a flexible material. The opening is covered by the valve body. Thereby, in a no-load state, the opening is covered by the valve body, so that it is possible to suppress entry of noise from the outside of the vehicle into the vehicle cabin. Further, when a pressure difference occurs between the inside of the vehicle cabin and the outside of the vehicle cabin, the valve body swings and the opening is temporarily opened, allowing the air inside the vehicle cabin to be discharged.

Further, the locking claw portion is provided with the swing limiting portion. This swing limiting portion limits swing of the upper portion of the valve body. As a result, the valve body has a structure in which a lower portion is bent in a state in which the upper portion is restrained, and the opening opens. Then, force is applied from the swing limiting portion to the valve body in a direction of covering the opening. Therefore, it is possible to suppress the valve body from flapping without increasing the mass of the valve body.

In the vehicle vent duct according to claim 2 of the present disclosure, in claim 1, the swing limiting portion is configured to include a contact surface that is provided at a position facing the valve body in the locking claw portion and comes into contact with the valve body when the valve body opens from a closed state in which the valve body covers the opening.

In the vehicle vent duct according to claim 2 of the present disclosure, the upper portion of the valve body comes into surface contact with the contact surface when the valve body swings, so that the upper portion of the valve body can be restrained.

In the vehicle vent duct according to claim 3 of the present disclosure, in claim 2, the contact surface is a curved surface that is curved such that the valve body side is protruded.

In the vehicle vent duct according to claim 3 of the present disclosure, the contact surface is a curved surface. Therefore, the valve body is bent and deformed so as to curve along the curved surface. Thereby, concentration of load on the valve body can be suppressed.

In the vehicle vent duct according to claim 4 of the present disclosure, in claim 3, a gap between an upper end portion of the curved surface and the duct body is made to be equal to a thickness of the valve body or slightly larger than the thickness of the valve body.

In the vehicle vent duct according to claim 4 of the present disclosure, the gap in the portion that restrains the valve body has approximately the same thickness as the thickness of the valve body. Thereby, the upper portion of the valve body can be restrained well. In addition, flapping of the valve body can be effectively suppressed.

In the vehicle vent duct according to claim 5 of the present disclosure, in any one of claims 1 to 4, a plurality of the locking claw portions and the valve bodies is arranged in an up-down direction; and the swing limiting portion located below is configured to have a larger restriction amount of swing of the valve body than the swing limiting portion located above.

In the vehicle vent duct according to claim 5 of the present disclosure, the lower valve body is less likely to swing than the upper valve body. This makes it possible to suppress entry of noise from below, such as road noise, into the vehicle cabin. In addition, the ventilation performance can be maintained by the large swing of the upper valve body.

As described above, according to the vehicle vent duct according to the present disclosure, it is possible to suppress entry of noise into the vehicle cabin while maintaining the ventilation performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle vent duct according to an embodiment is applied, viewed from the rear side;

FIG. 2 is a front view of the vehicle vent duct according to the embodiment;

FIG. 3A is an enlarged sectional view of main parts taken along line IIIA-IIIA in FIG. 2, showing the vehicle vent duct in a closed state;

FIG. 3B is an enlarged sectional view of main parts taken along line IIIB-IIIB in FIG. 2, showing the vehicle vent duct in an open state;

FIG. 4A is an enlarged cross-sectional view of main parts showing an open state of a vehicle vent duct in a modified example, and shows a cross section of the uppermost stage;

FIG. 4B is an enlarged sectional view of main parts showing an open state of a vehicle vent duct in a modified example, and shows a middle section;

FIG. 4C is an enlarged sectional view of main parts showing an open state of a vehicle vent duct in a modified example, and shows a cross section of the lowest stage; and

FIG. 5 is an enlarged sectional view of a main part corresponding to FIGS. 3A and 3B, showing a vehicle vent duct according to a comparative example.

### DETAILED DESCRIPTION OF EMBODIMENTS

Hereinafter, a vehicle vent duct 10 according to an embodiment will be described with reference to the drawings. Note that the arrow UP shown as appropriate in each figure indicates the upper side of the vehicle. Arrow FR shown as appropriate in each figure indicates the front side of the vehicle. An arrow LH shown as appropriate in each figure indicates the left side in the vehicle width direction (horizontal direction). In addition, in the following description, when front and rear, up and down, and left and right directions are used unless otherwise specified, they refer to front and rear in the vehicle front and rear direction, up and down in the vehicle up and down direction, and left and right when facing the direction of travel.

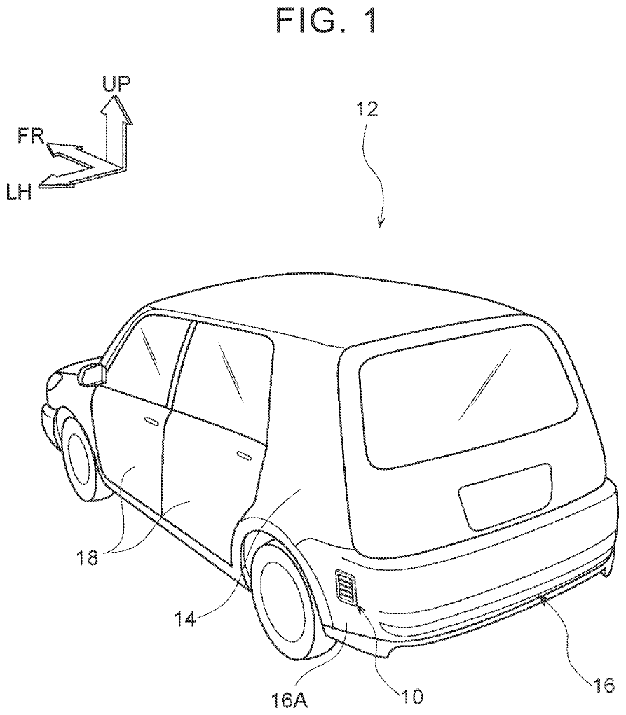

FIG. 1 is a perspective view of a vehicle 12 to which a vehicle vent duct 10 according to an embodiment is applied, viewed from the rear side. As shown in FIG. 1, the vehicle vent duct 10 of this embodiment is a quarter vent duct provided at the rear side of a vehicle (vehicle body) 12. Hereinafter, the vehicle vent duct 10 will be appropriately referred to as the “vent duct 10.” Specifically, the vent duct 10 is provided in the quarter panel 14. The quarter panel 14 constitutes a part of the outer panel of the vehicle 12 and separates the inside of the vehicle cabin from the outside of the vehicle cabin.

The vent duct 10 is covered by a portion 16A of the rear bumper cover 16 on the outside in the vehicle width direction. However, in FIG. 1, for convenience of explanation, the vent duct 10 is shown in a state visible from the outside of the vehicle. For example, when the pressure inside the vehicle becomes higher than the pressure outside the vehicle, such as when an air conditioner (not shown) is activated or when the side door 18 is closed, the air inside the vehicle cabin is configured to be discharged to the outside of the vehicle cabin through the vent duct 10. In addition, in this embodiment, the vent duct 10 is provided on the left side of the vehicle 12. However, the present disclosure is not limited to this, and the vent duct 10 may be provided on the right side of the vehicle 12. Further, the vent ducts 10 may be provided on both left and right sides of the vehicle 12. Further, the vent duct 10 may be provided in other parts of the vehicle 12.

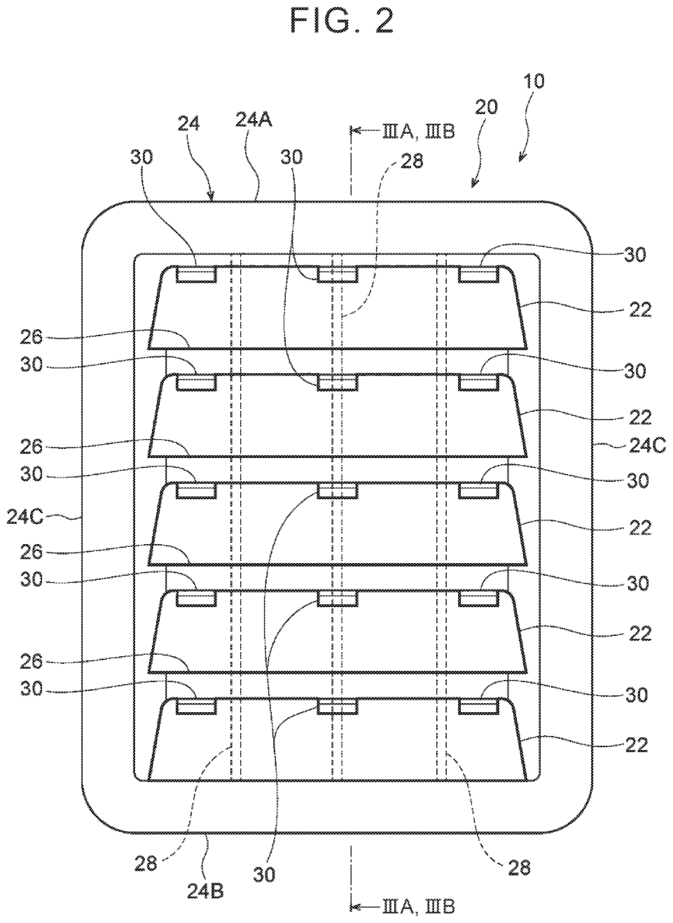

FIG. 2 is a front view of the vent duct 10 according to the embodiment. As shown in FIG. 2, the vent duct 10 mainly includes a duct body 20 and five valve bodies 22. The duct body 20 is formed of a resin component. The duct body 20 includes a frame body 24 in the shape of a substantially rectangular frame whose longitudinal direction is the vertical direction of the vehicle when viewed from the side of the vehicle. However, the shape of the duct body 20 is not particularly limited.

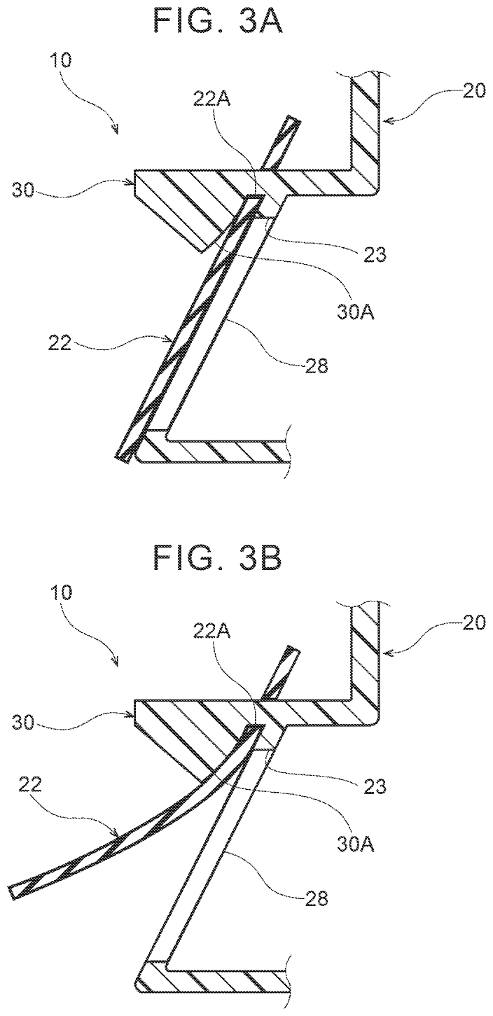

The frame body 24 includes an upper wall portion 24A, a lower wall portion 24B, and a pair of side wall portions 24C. The upper wall portion 24A is located at the upper portion and extends in the vehicle longitudinal direction (horizontal direction in the drawing). The lower wall portion 24B is located at the lower portion and extends in the vehicle longitudinal direction. A pair of side wall portions 24C connect the ends of the upper wall portion 24A and the lower wall portion 24B. Here, as shown in FIG. 3A, an opening 23 is formed inside the frame body 24. This opening 23 allows communication between the inside of the vehicle cabin and the outside of the vehicle cabin. Further, the opening 23 is closed from the outside of the vehicle cabin by the valve body 22.

As shown in FIG. 2, the duct body 20 is provided with a horizontal connecting portion 26 that connects the pair of side wall portions 24C of the frame body 24. The horizontal connecting portions 26 are provided at equal intervals in the vertical direction of the duct body 20. In this embodiment, as an example, four horizontal connecting portions 26 are provided. Therefore, the opening 23 is divided into five sections by the upper wall portion 24A, the lower wall portion 24B, and the four horizontal connecting portions 26. This embodiment has a structure in which five valve bodies 22 cover each opening 23, as an example.

Further, the duct body 20 is provided with a plurality of ribs 28 that connect the upper wall portion 24A and the lower wall portion 24B of the frame body 24. In this embodiment, three ribs 28 are provided. The horizontal connecting portions 26 are vertically connected by ribs 28. Each of the ribs 28 is inclined outward in the vehicle width direction from the top to the bottom. The back surface of the valve body 22 is supported by the ribs 28.

Here, the duct body 20 is provided with a plurality of locking claw portions 30. The valve body 22 is locked to these locking claw portions 30. In this embodiment, as an example, three locking claw portions 30 are provided on the upper edge of each of the five divided openings 23. The valve body 22 is locked to the duct body 20 by three locking claw portions 30.

FIG. 3A is an enlarged sectional view of a main part taken along line IIIA-IIIA in FIG. 2. FIG. 3B is an enlarged sectional view of a main part taken along line IIIB-IIIB in FIG. 2. As shown in FIG. 3A, the locking claw portion 30 projects outward from the upper edge of the opening 23 in the vehicle width direction. The locking claw portion 30 is formed in a shape whose thickness in the vertical direction gradually becomes thinner from the machine end toward the tip. Further, the locking claw portion 30 is integrally formed with the duct body 20. A valve body 22 is attached between the locking claw portion 30 and the duct body 20.

At a position in the locking claw portion 30 facing the valve body 22, a swing limiting portion and a curved surface 30A as a contact surface are formed, which are curved so that the valve body 22 side is convex. The curved surface 30A is a surface that comes into contact with the valve body 22 when it opens from the closed state covering the opening 23. By the valve body 22 coming into contact with this curved surface 30A, the swinging of the upper part of the valve body 22 is restricted.

The valve body 22 is made of a flexible material and is formed into a sheet shape. In this embodiment, as an example, the valve body 22 is formed of a rubber sheet. An attachment hole 22A is formed in the upper part of the valve body 22 and penetrates in the thickness direction. The size of the attachment hole 22A is approximately the same as the base end portion of the locking claw portion 30 in the duct body 20.

The valve body 22 is formed of a thin rubber sheet. Therefore, the attachment hole 22A can be enlarged. The valve body 22 is configured to be attached to the duct body 20 by inserting the attachment hole 22A from the distal end side of the locking claw portion 30. Further, the valve body 22 is pivotally locked to the locking claw portion 30 and covers the opening 23.

The valve body 22 is formed with substantially the same thickness from the upper end to the lower end. The thickness of the valve body 22 is approximately the same as the gap between the locking claw portion 30 and the duct body 20. Note that in consideration of dimensional errors during manufacturing, the gap between the locking claw portion 30 and the duct body 20 may be formed to be slightly larger than the thickness of the valve body 22.

Here, FIG. 3A shows a closed state in which the opening 23 is covered by the valve body 22. In this closed state, the opening 23 is closed. Therefore, ventilation is not performed between the inside of the vehicle cabin and the outside of the vehicle cabin. Furthermore, the valve body 22 suppresses noise generated outside the vehicle 12 from entering the vehicle cabin.

Furthermore, in this embodiment, the thickness of the valve body 22 is approximately the same thickness as the gap between the locking claw portion 30 and the duct body 20. Therefore, in the closed state, the upper part of the valve body 22 is in contact with the upper end of the curved surface 30A of the locking claw portion 30.

In the closed state shown in FIG. 3A, when the pressure inside the vehicle cabin becomes higher than the pressure outside the vehicle cabin, such as when an air conditioner (not shown) is activated or when the side door 18 is closed, the closed state shown in FIG. 3A transitions to the open state shown in FIG. 3B.

As shown in FIG. 3B, in the open state, the valve body 22 swings toward the outside of the vehicle due to the pressure difference between the interior and exterior of the vehicle cabin. Then, the opening 23 is opened. At this time, the area around the attachment hole 22A of the valve body 22 is restrained by the locking claw portion 30 and the duct body 20, and the portion below the attachment hole 22A is deflected to a position where it makes surface contact with the curved surface 30A.

When the air inside the vehicle cabin is discharged from the opening 23 and the pressure inside the vehicle cabin and outside the vehicle cabin become the same, the valve body 22 returns to the closed state due to the force received from the curved surface 30A of the locking claw portion 30 and the restoring force of the valve body 22 itself.

### Operations

Next, the operation of this embodiment will be explained.

The vent duct 10 according to this embodiment includes a duct body 20 that is attached to a vehicle body. Further, the duct body 20 is formed with an opening 23 that communicates the inside of the vehicle cabin with the outside of the vehicle cabin. Furthermore, a locking claw portion 30 is provided on the upper edge of the opening 23 in the duct body 20. The valve body 22 is locked to the locking claw portion 30 in a swingable manner.

Here, the valve body 22 is made of a flexible material. The opening 23 is covered by the valve body 22. Thereby, as shown in FIG. 3A, the opening 23 is covered by the valve body 22 in the no-load state, thereby suppressing noise from outside the vehicle from entering the vehicle cabin.

Furthermore, when a pressure difference occurs between the inside and outside of the vehicle, as shown in FIG. 3B, the valve body 22 swings and the opening 23 is temporarily opened, allowing the vehicle cabin to be ventilated. Here, the locking claw portion 30 is provided with a curved surface 30A. This curved surface 30A limits the swinging of the upper part of the valve body 22. Thereby, the valve body 22 has a structure in which the opening 23 is opened by bending the lower part while the upper part is restrained. Then, a force is applied from the curved surface 30A to the valve body 22 in a direction that covers the opening 23. Thereby, it is possible to suppress the valve body 22 from flapping without increasing the mass of the valve body 22. That is, the vent duct 10 according to the present embodiment can suppress noise from entering the vehicle cabin while maintaining ventilation performance.

Furthermore, in this embodiment, the upper part of the valve body 22 can be restrained by bringing the upper part of the valve body 22 into surface contact with the curved surface 30A when the valve body 22 swings. In particular, as in this embodiment, since the contact surface is the curved surface 30A, the valve body 22 is deformed so as to curve along the curved surface 30A. Thereby, concentration of load on the valve body 22 can be suppressed. That is, when the contact surface is a flat surface, the valve body 22 deforms so as to be bent from the lower end of the contact surface. Therefore, there is a possibility that the load will be concentrated on the bent portion. In contrast, in this embodiment, the contact surface is a curved surface 30A that is convex toward the valve body 22 side. Therefore, the valve body 22 can be flexibly deformed into a shape along the curved surface 30A. In addition, concentration of load on the valve body 22 can be suppressed.

Furthermore, in this embodiment, the gap in the portion that restricts the valve body 22 is approximately the same as the thickness of the valve body 22. Thereby, the upper part of the valve body 22 can be restrained well. In addition, it is possible to effectively prevent the valve body 22 from flapping.

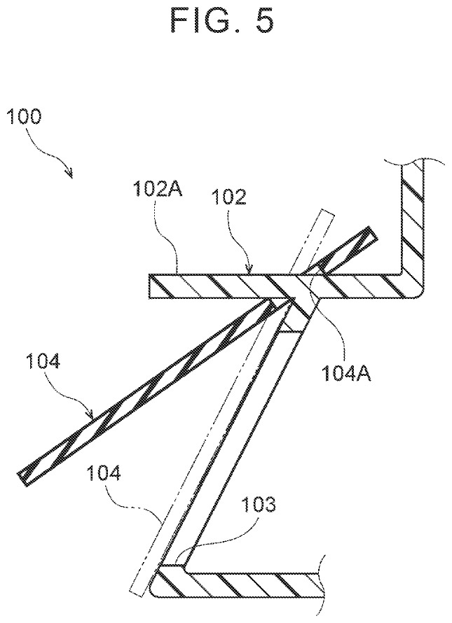

These effects will be explained in comparison with the vent duct 100 of a comparative example. FIG. 5 shows a vehicle vent duct according to a comparative example. Further, FIG. 5 is an enlarged sectional view of a main part corresponding to FIGS. 3A and 3B. As shown in FIG. 5, the vent duct 100 of the comparative example includes a duct body 102. The duct body 102 has the same structure as the vent duct 10 of this embodiment except that it does not include the locking claw portion 30.

An opening 103 is formed in the vent duct 100. The inside of the vehicle cabin and the outside of the vehicle cabin are communicated through the opening 103. Further, the opening 103 is covered by a valve body 104 attached to the duct body 102.

The valve body 104 is formed of a rubber sheet similarly to this embodiment. An attachment hole 104A is formed in the upper part of the valve body 104. A mounting pin 102A formed in the duct body 102 is inserted through the attachment hole 104A. The attachment hole 104A is configured to be swingable relative to the duct body 102. In addition, in FIG. 5, the closed state of the valve body 104 is shown by a two-dot chain line. In FIG. 5, the open state is shown by a solid line.

The vent duct 100 of the comparative example is configured as described above. Therefore, even in the open state, the upper part of the valve body 104 is not restricted. Then, the valve body 104 swings with almost no bending. For this reason, the valve body may flap due to the influence of airflow and vibrations of the vehicle when the vehicle is running. In addition, noise may frequently enter the vehicle cabin.

On the other hand, in the vent duct 10 according to the present embodiment, the valve body 22 is locked by the locking claw portion 30, as shown in FIG. 3B. In the open state, the upper part of the valve body 22 is restrained. Thereby, it is possible to prevent the valve body 22 from opening due to the influence of airflow, vehicle vibration, or the like.

Moreover, in this embodiment, the upper part of the valve body 22 is in contact with the locking claw portion 30. Therefore, it is possible to suppress the valve body 22 from warping and bending. Furthermore, the assembly of the valve body 22 is completed by completely inserting the valve body 22 into the locking claw portion 30. Therefore, it is possible to easily check for defects in the assembly of the valve body 22.

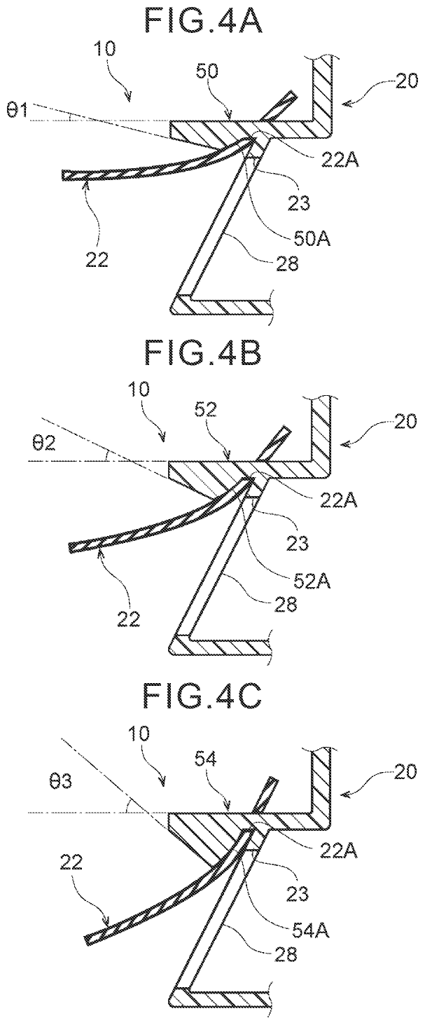

In addition, in this embodiment, as shown in FIG. 2, all the locking claw portions 30 provided in five stages in the vertical direction were made into the same shape, but it is not limited to this. For example, the modified configurations shown in FIGS. 4A, 4B, and 4C may be adopted.

### Modifications

FIGS. 4A, 4B, and 4C are enlarged cross-sectional views of main parts showing an open state of the vehicle vent duct 10 in a modified example. Here, FIG. 4A shows a cross section of the uppermost stage of the duct body 20. Further, FIG. 4B shows a cross section of the middle stage, that is, the third stage from the top. Further, FIG. 4C shows a cross section of the lowest stage.

As shown in FIG. 4A, the locking claw portion 50 formed at the uppermost stage of the duct body 20 has an angle of θ1 between the substantially horizontally extending upper surface and the lower surface. Further, a curved surface 50A is formed in a portion of the locking claw portion 50 that faces the valve body 22.

As shown in FIG. 4B, the locking claw portion 52 formed at the middle (third stage) of the duct body 20 has an angle of θ2 between the upper surface extending substantially horizontally and the lower surface. Further, a curved surface 52A is formed in a portion of the locking claw portion 52 that faces the valve body 22.

As shown in FIG. 4C, the locking claw portion 54 formed at the lowermost stage of the duct body 20 has an angle of θ3 between an upper surface extending substantially horizontally and a lower surface. Further, a curved surface 54A is formed in a portion of the locking claw portion 54 that faces the valve body 22.

Here, in this modification, the relationship θ1<θ2<θ3 holds true. Therefore, the curved surface 52A is formed longer than the curved surface 50A. The curved surface 54A is formed longer than the curved surface 52A. Therefore, in this modification, the amount of restriction on the swing of the valve body 22 is configured to be larger on the curved surface located below than on the curved surface located above.

Note that the angle of the locking claw portion formed at the second stage from the top of the duct body 20 may be either θ1 or θ2, or may be formed at an angle between θ1 and θ2. Similarly, the angle of the locking claw portion formed at the fourth stage from the top of the duct body 20 may be either θ2 or θ3, or may be formed at an angle between θ2 and θ3.

According to this modification, the valve body 22 attached below the duct body 20 is less likely to swing than the valve body 22 attached above the duct body 20. This makes it possible to suppress entry of noise from below, such as road noise, into the vehicle cabin. Moreover, ventilation performance can be maintained because the upper valve body 22 swings greatly.

The vent duct 10 according to the embodiment and the modified example has been described above. However, it goes without saying that the present disclosure can be implemented in various ways without departing from the spirit of the disclosure. In the above embodiment, the duct body 20 was formed of a resin component, and the valve body 22 was formed of a rubber sheet. However, the duct body 20 and the valve body 22 are not limited to this, and may be formed of other materials. For example, at least one of the duct body 20 and the valve body 22 may be formed of a material containing a sound absorbing material. In this case, even if the valve body 22 is in the open state, part of the noise entering the inside of the vehicle cabin from the outside the vehicle cabin.

Further, in the embodiment described above, the friction coefficient of the vehicle inner side surface of the valve body 22 may be increased. In this case, when the valve body 22 is in the closed state, the frictional force acting between the valve body 22 and the duct body 20 can prevent the valve body 22 from easily separating from the duct body 20. Furthermore, the same effect can be obtained by increasing the coefficient of friction of the surfaces of the horizontal connecting portion 26 and ribs 28 of the duct body 20 that contact the valve body 22. Note that methods for increasing the coefficient of friction include a method of pasting a material with a high coefficient of friction, a method of applying a material with a high coefficient of friction, a method of roughening the surface, and the like.

Furthermore, in the above embodiment, as shown in FIG. 2, five valve bodies 22 are arranged vertically, but the present disclosure is not limited to this. For example, the number of valve bodies 22 arranged vertically may be less than four, or may be six or more. Further, a plurality of valve bodies 22 may be arranged in the vehicle longitudinal direction (left and right direction in the drawing).

Furthermore, in the above embodiment, as shown in FIGS. 3A and 3B, the locking claw portion 30 is provided with the curved surface 30A, but the present disclosure is not limited thereto. For example, the surface of the locking claw portion 30 facing the valve body 22 may be flat. Further, for example, the locking claw portion 30 may be formed in a folded shape. Further, for example, the cross section may be approximately V-shaped with the inside of the vehicle cabin open. In this case, the folded end portion of the locking claw portion 30 corresponds to the “swing limiting portion” of the present disclosure. Further, the folded tip portion and the valve body 22 come into contact with each other at a point to restrict the swinging of the valve body 22, but the function of restraining the upper part of the valve body 22 as in the present embodiment is achieved. play.

What is claimed is:

1. A vehicle vent duct comprising:
a duct body that is attached to a vehicle body and configured to include an opening that communicates an inside of a vehicle cabin with an outside of the vehicle cabin, and a locking claw portion provided at an upper edge of the opening; and
a valve body that is locked to the locking claw portion of the duct body in a swingable state and covers the opening, the valve body being made of a flexible material, wherein the locking claw portion is provided with a swing limiting portion that limits swing of an upper portion of the valve body.

2. The vehicle vent duct according to claim 1, wherein the swing limiting portion is configured to include a contact surface that is provided at a position facing the valve body in the locking claw portion and comes into contact with the valve body when the valve body opens from a closed state in which the valve body covers the opening.

3. The vehicle vent duct according to claim 2, wherein the contact surface is a curved surface that is curved such that the valve body side is protruded.

4. The vehicle vent duct according to claim 3, wherein a gap between an upper end portion of the curved surface and the duct body is made to be equal to a thickness of the valve body or slightly larger than the thickness of the valve body.

5. The vehicle vent duct according to claim 1, wherein:
a plurality of the locking claw portions and the valve bodies is arranged in an up-down direction; and
the swing limiting portion located below is configured to have a larger restriction amount of swing of the valve body than the swing limiting portion located above.
